(19) United States
(12) Patent Application Publication
(10) Pub. No.: US 2021/0299846 A1
(43) Pub. Date: Sep. 30, 2021

(54) CLEANING TOOL

(71) Applicant: JIASHAN MASTER TOP INT'L INC., Jiaxing City (CN)

(72) Inventor: Chia-Cheng CHEN, Jiaxing City (CN)

(73) Assignee: JIASHAN MASTER TOP INT'L INC., Jiaxing City (CN)

(21) Appl. No.: 16/833,051

(22) Filed: Mar. 27, 2020

(51) Int. Cl. B25G 1/04; B08B 1/00; B25G 1/02; B25G 1/10

(52) U.S. Cl. CPC B25G 1/04; B25G 1/10; B25G 1/02; B08B 1/002

(57) ABSTRACT

A cleaning tool including a holding rod and a first tool assembly, wherein the holding rod is curved to form an inner curve and an outer curve. The first tool assembly is rotatably connected to a first end of the holding rod. The first tool assembly includes a first side and a second side which face opposite directions, wherein the first side or the second side is controllably fixed relative to the holding rod to make either the first side or the second side faces a direction to the same as the inner curve. When a high surface of a subject has obstacles, the user could easily clean up the dead corners around the obstacles by using the cleaning tool with curving holding rod provided by the present invention.

### BACKGROUND OF THE INVENTION

### Technical Field

The present invention relates generally to a cleaning tool, and more particularly to a cleaning tool which has a rotatable working assembly and has a curving holding rod.

### Description of Related Art

As shown in FIG. 1, a conventional cleaning tool 1 includes a holding rod 12 and a working head 14, wherein the working head 14 is connected to the holding rod 12. When a user P needs to clean a high platform S (e.g. a car roof), generally the cleaning tool 1 is used for assistance. However, when the user P clean the high platform S by the cleaning tool 1, the user P needs to raise hands up or to stand on a ladder, in order to easily clean up the high platform S by the cleaning tool 1.

Additionally, when there are obstacles protruded on an edge of the high platform S, the holding rod 12 of the conventional cleaning tool 1 will be hindered by the obstacles O, so that the user P has to raise hands up or to stand on the ladder to make the working head 14 of the cleaning tool 1 reach the high platform S. However, partial places of the high platform S which are around the obstacles O are still hard to be cleaned by the conventional cleaning tool 1, so that a user P has to stand on a higher place or uses other cleaning tools (not shown) to clean up such place. Therefore, a risk of injury caused by falling down from the high place is increased; on the other sides, a cost of cleaning the high platform S is increased due to using other cleaning tools.

To sum up, the conventional cleaning tool 1 still has room for improvement, in order to overcome a problem that the high platform is hard to be cleaned up.

### BRIEF SUMMARY OF THE INVENTION

In view of the above, the primary objective of the present invention is to provide a cleaning tool which facilitates a user to easily clean up dead corners around obstacles on the high surface of a subject by a curving holding rod of the cleaning tool.

The present invention provides a cleaning tool including a holding rod and a first tool assembly, wherein the holding rod is curved to form an inner curve and an outer curve; the first tool assembly is rotatably connected to a first end of the holding rod and includes a first side and a second side which face opposite directions. The first side or the second side is controllably fixed relative to the holding rod to allow either the first side or the second side faces a direction from the outer curve to the inner curve.

In an embodiment, the first tool assembly includes a rotatable member and a connecting portion. The rotatable member includes the first side and the second side and is rotatably connected to the connecting portion. The connecting portion is fixed to the first end of the holding rod. Either the rotatable member or the connecting portion includes at least one protruding member and the other one includes at least one positioning groove. When either the first side or the second side faces the direction from the outer curve to the inner curve, the at least one protruding member is correspondingly engaged with the at least one positioning groove.

In an embodiment, the at least one protruding member includes a first pressed portion, a first abutting portion, and a first resisting portion. The first pressed portion and the first abutting portion are located on a side of the at least one protruding member, and the first resisting portion is located on another side of the at least one protruding member opposite to the side with the first pressed portion and the first abutting portion. The first resisting portion is connected to a first elastic member. When the at least one protruding member is correspondingly engaged with the at least one positioning groove, the at least one protruding member is resisted by the first elastic member to make the first abutting portion abut against the at least one positioning groove. When the first pressed portion is pressed by an external force, the at least one protruding member is moved in a direction toward the first elastic member, so that the first abutting portion is disengaged from the at least one positioning groove, thereby the rotatable member is freely rotatable relative to the connecting portion.

In an embodiment, the first tool assembly includes a rotational axis, and the rotatable member is connected to the connecting portion via the rotational axis. An axial direction of the rotational axis is paralleled to a longitudinal direction of the holding rod.

In an embodiment, the first end of the holding rod includes a connecting assembly. The connecting assembly includes a pivotable member and a fixing member. An end of the pivotable member is connected to the first tool assembly, and another end of the pivotable member is pivotally connected to the fixing member. The fixing member is fixed to an end of a rod body of the holding rod.

In an embodiment, either the pivotable member or the fixing member includes a positioning flange, and the other one includes at least one positioning recess. When the pivotable member pivots relative to the fixing member, and the positioning flange corresponds to the at least one positioning recess, the positioning flange is engaged with the at least one positioning recess.

In an embodiment, the positioning flange includes a second pressed portion, a second abutting portion, and a second resisting portion. The second pressed portion and the second abutting portion are located on a side of the positioning flange, and the second resisting portion is located on another side opposite to the side with the second pressed portion and the second abutting portion. The second resisting portion is connected to a second elastic member. When the positioning flange is engaged with the at least one positioning recess, the positioning flange is resisted by the second elastic member to make the second abutting portion abut against the at least one positioning recess. When the second pressed portion is pressed by an external force, the positioning flange is moved in a direction toward the second elastic member, so that the second abutting portion is disengaged from the at least one positioning recess, thereby the pivotable member is freely rotatable relative to the fixing member.

In an embodiment, the connecting assembly includes a pivotal axis. The pivotable member is connected to the fixing member via the pivotal axis. The at least one positioning recess includes a plurality of positioning recesses which are arranged around the pivotal axis. When the positioning flange corresponds to and is engaged with one of the positioning recesses, the pivotable member are unable to pivot relative to the fixing member.

In an embodiment, an axial direction of the pivotal axis is perpendicular to a longitudinal direction of the holding rod.

In an embodiment, the holding rod includes an inner tube, an outer tube, and a fixing structure. The outer tube fits around the inner tube. The fixing structure is disposed on the outer tube. When the fixing structure is in a lock state, the outer tube is unable to move relative to the inner tube. When the fixing structure is in an unlock state, the outer tube and the inner tube are controllably moved relative to each other in a longitudinal direction of the holding rod.

In an embodiment, a wall of the inner tube includes at least one positioning perforation. The fixing structure includes a positioning member. When the fixing structure is in the lock state, the positioning member is correspondingly engaged with the at least one positioning perforation, thereby the outer tube and the inner tube are unable to move relative to each other.

In an embodiment, the fixing structure includes a third pressed portion, the positioning member, and a third resisting portion. The third pressed portion and the third resisting portion face opposite directions and are located at a side of a fulcrum of the fixing structure. The positioning member is located at another side of the fulcrum opposite to the side with the third pressed portion and the third resisting portion. The third resisting portion is connected to a third elastic member. When the positioning member is correspondingly engaged with the at least one positioning perforation, the third resisting portion is resisted by the third elastic member to make positioning member abut against the at least one positioning perforation. When the third pressed portion is pressed by an external force, the positioning member moves away from the at least one positioning perforation to disengage the positioning member and the at least one positioning perforation, so that the fixing structure is in the unlock state, thereby the outer tube and the inner tube are controllably moved relative to each other in the longitudinal direction of the holding rod.

In an embodiment, the cleaning tool includes a second tool assembly connected to a second end of the holding rod, wherein the second end is opposite to the first end.

When the high surface of the subject has the obstacles, since the cleaning tool provided by the present invention has the curving holding rod, the user could easily clean up dead corners around the obstacles without climbing high, thereby to decrease the risk of injury caused by falling down from the high place. On the other sides, the dead corners around the obstacles could be easily cleaned up by using the cleaning tool having the curving holding rod, so that the user is not necessary to use other cleaning tools, thereby to save the cost of cleaning work.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic diagram, showing a conventional cleaning tool;

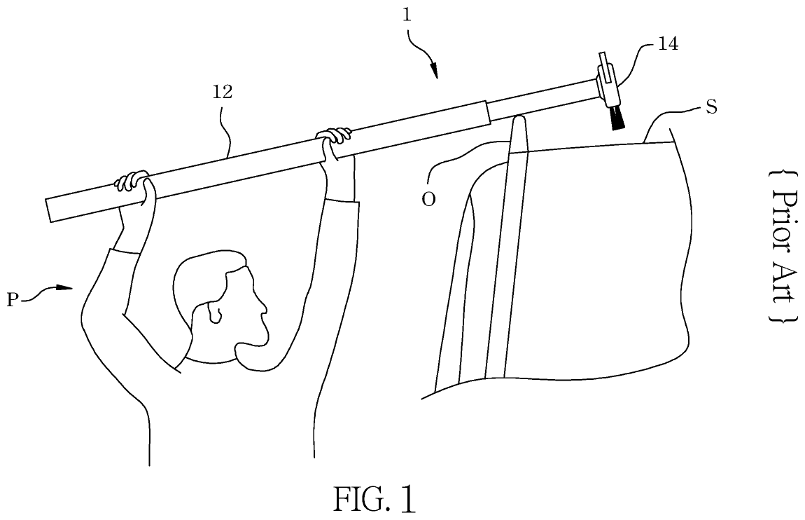

FIG. 2 is a schematic diagram, showing the cleaning tool of an embodiment according to the present invention;

FIG. 3 is a side view of the cleaning tool of the embodiment of the present invention;

FIG. 4 is an enlarged partial view of a marked region A in FIG. 3, showing top view of the first tool assembly of the present invention;

FIG. 5 is a partial sectional view taken along the 5-5 line in FIG.4;

FIG. 6 is an enlarged partial view of a marked region B in FIG. 3, showing top view of the positioning buckle;

FIG. 7 is a partial sectional view taken along the 7-7 line in FIG.6;

FIG. 8 is a partial sectional view, showing the holding rod and the fixing structure of the cleaning tool of the embodiment of the present invention.

### DETAILED DESCRIPTION OF THE INVENTION

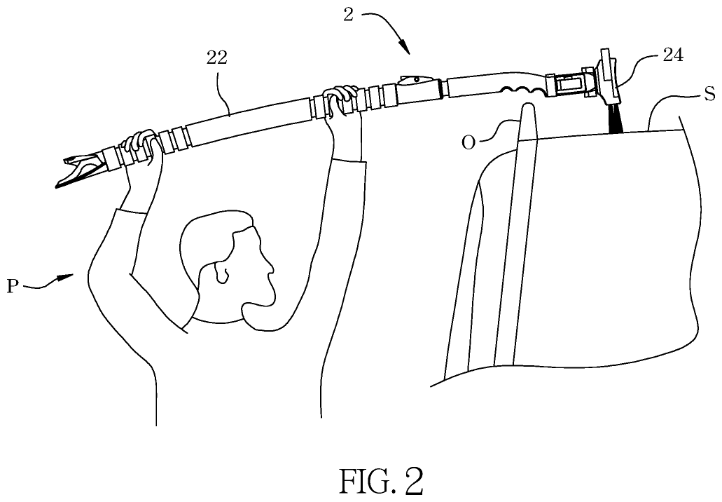

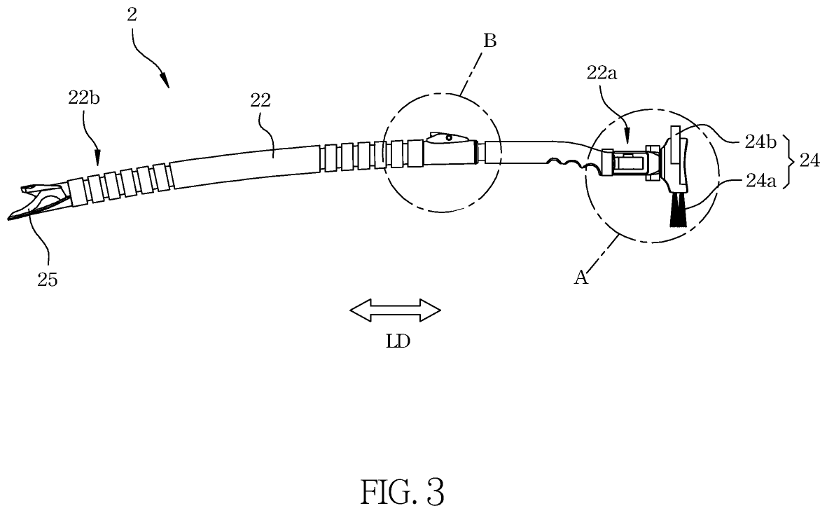

As illustrated in FIG. 2 and FIG. 3, a cleaning tool 2 of an embodiment according to the present invention includes a holding rod 22 and a first tool assembly 24.

Referring to FIG. 2 and FIG. 3, the rod 22 is curved to form an inner curve and an outer curve, wherein the holding rod 22 is curved in a direction from the outer curve to the inner curve. The first tool assembly 24 is rotatably connected to a first end 22a of the holding rod 22 and includes a first side 24a and a second side 24b which face opposite directions, wherein the first tool assembly 24 is controllably fixed relative to the holding rod 22 to allow either the first side 24a or the second side 24b of the first tool assembly 24 faces the direction from the outer curve to the inner curve. In the current embodiment, the cleaning tool 2 could further include a second tool assembly 25 connected to a second end 22b of the holding rod 22 depending on the required demand, wherein the second end 22b is opposite to the first end 22a. In the current embodiment, the second tool assembly 25 could be, but not limited to, a deicing shovel.

Referring to FIG. 2, since the holding rod 22 of the cleaning tool 2 is curve-shaped, when a user P cleans up a high surface S by the cleaning tool 2, the first tool assembly 24 of the cleaning tool 2 could easily crossover obstacles O located on the high surface S to contact with the high surface S without being hindered by the obstacles O. In this way, the user P could easily clean up dead corners around the obstacles O, so that a work of cleaning the high surface S becomes more convenient and easy. Additionally, with the cleaning tool 2 of present invention, the user P could avoid climbing high, thereby to decrease a risk of injury caused by falling down from a high place. On the other sides, the dead corners around the obstacles O could be easily cleaned up by using the cleaning tool 2 provided by the present invention having the holding rod 22 in curve shape, so that it's unnecessary to use other cleaning tools, thereby to save a cost of cleaning work.

Referring to FIG. 3, the first side 24a of the first tool assembly 24 is disposed with a brush head adapted to brush dust on an uncleaned surface, and the second side 24b of the first tool assembly 24 is disposed with a scraper blade adapted to scrape away piles of objects on the uncleaned surface. For example, in the current embodiment, the cleaning tool 2 could be a snow scraper adapted to scrape away the snow accumulated on a car roof (i.e., the high surface S in FIG. 2). Since the holding rod 22 is curve-shaped, the first tool assembly 24 of the cleaning tool 2 could easily crossover car racks (i.e., the obstacles O in FIG. 2) protruding upward and located on the car roof without being hindered by the car racks. In this way, the user P could easily clean up the accumulated snow on the car roof, so that the work of cleaning the car roof becomes more convenient and easy.

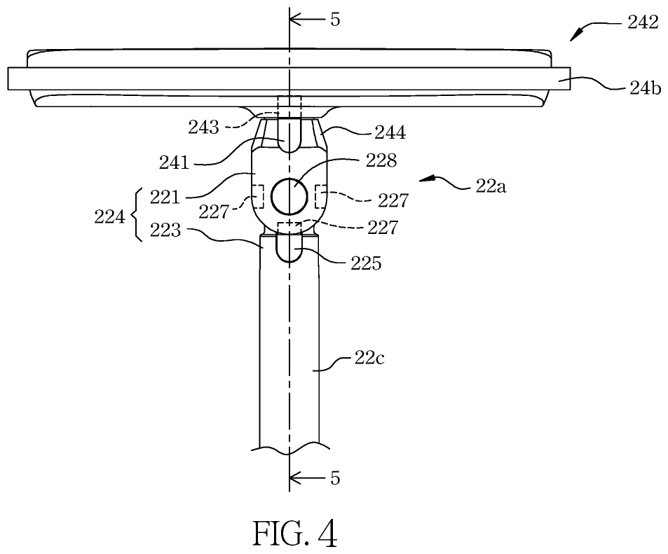

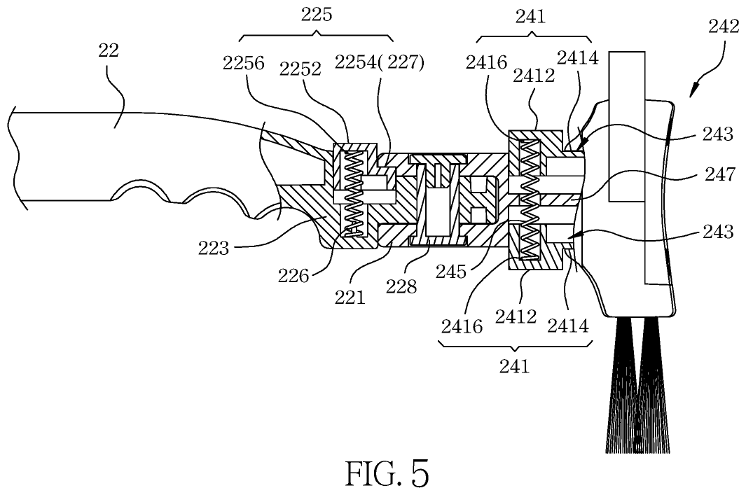

As illustrated in FIG. 4 and FIG. 5, the first tool assembly 24 includes a rotatable member 242 and a connecting portion 244. The first side 24a and the second side 24b and is rotatably connected to the connecting portion 244. The connecting portion 244 is fixed to the first end 22a of the holding rod 22.

Either the rotatable member 242 or the connecting portion 244 includes at least one protruding member 241, and the other one which is not disposed with the at least one protruding member 241 includes at least one positioning groove 243, wherein the protruding member 241 and the positioning groove 243 are adapted to position the rotatable member 242 and the connecting portion 244. When either the first side 24a or the second side 24b faces the direction from the outer curve to the inner curve (i.e., either the first side 24a or the second side 24b faces a same direction with the inner curve), the protruding member 241 is correspondingly engaged with the positioning groove 243 by interlocking. In the current embodiment, the connecting portion 244 has two protruding members 241 facing opposite directions, and the rotatable member 242 has two positioning grooves 243 facing opposite directions. When either the first side 24a or the second side 24b faces the direction from the outer curve to the inner curve, each of the two protruding members 241 is correspondingly engaged with one of the two positioning grooves 243, thereby to prevent the rotatable member 242 from rotating relative to the connecting portion 244.

Each of the protruding members 241 includes a first pressed portion 2412, a first abutting portion 2414, and a first resisting portion 2416, wherein the first pressed portion 2412 and the first abutting portion 2414 are located at a side of the protruding member 241, and the first resisting portion 2416 is located on another side of the protruding member 241 opposite to the side with the first pressed portion 2412 and the first abutting portion 2414. Each of the first resisting portions 2416 is connected to a first elastic member 245. When the protruding member 241 is correspondingly engaged with the positioning groove 243, the protruding member 241 is resisted by the first elastic member 245 to make the first abutting portion 2414 abut against the positioning groove 243.

On contrary, when the first pressed portion 2412 is pressed by an external force, the protruding member 241 is moved in a direction toward the first elastic member 245, so that the first abutting portion 2414 is disengaged from the positioning groove 243, thereby the rotatable member 242 could freely rotate relative to the connecting portion 244. When the user P want to change the brush head on the first side 24a of the first tool assembly 24 into the scraper blade on the second side 24b, the user P could simply press the first pressed portion 2412 to make the rotatable member 242 freely rotate relative to the connecting portion 244, and then turn the rotatable member 242 through 180 degrees to make the scraper blade on the second side 24b face the direction from the outer curve to the inner curve.

Referring to FIG. 5, the first tool assembly 24 includes a rotational axis 247, wherein the rotatable member 242 is connected to the connecting portion 244 via the rotational axis 247. In the current embodiment, an axial direction of the rotational axis 247 is parallel to a longitudinal direction LD of the holding rod 22.

The first end 22a of the holding rod 22 includes a connecting assembly 224 including a pivotable member 221 and a fixing member 223, wherein an end of the pivotable member 221 is connected to the first tool assembly 24, and another end of the pivotable member 221 is pivotally connected to the fixing member 223. The fixing member 223 is fixed to an end of a rod body 22c of the holding rod 22.

Either the pivotable member 221 or the fixing member 223 includes a positioning flange 225, and the other one which does not include the positioning flange 225 includes at least one positioning recess 227. When the pivotable member 221 pivot relative to the fixing member 223 to make the positioning flange 225 correspond to the positioning recess 227, the positioning flange 225 is correspondingly engaged with the positioning recess 227, thereby to position the pivotable member 221 and the fixing member 223.

In the illustrated embodiment, the positioning flange 225 includes a second pressed portion 2252, a second abutting portion 2254, and a second resisting portion 2256, wherein the second pressed portion 2252 and the second abutting portion 2254 are located on a side of the positioning flange 225, and the second resisting portion 2256 is located on another side opposite to the side with the second pressed portion 2252 and the second abutting portion 2254.

The second resisting portion 2256 is connected to a second elastic member 226. When the positioning flange 225 is correspondingly engaged with the positioning recess 227, the positioning flange 225 is resisted by the second elastic member 226 to make the second abutting portion 2254 abut against the positioning recess 227. On contrary, when the second pressed portion 2252 is pressed by an external force, the positioning flange 225 is moved in a direction toward the second elastic member 226, so that the second abutting portion 2254 is disengaged from the positioning recess 227, thereby the pivotable member 221 could freely rotate relative to the fixing member 223.

The connecting assembly 224 includes a pivotal axis 228, wherein the pivotable member 221 is connected to the fixing member 223 via the pivotal axis 228. In the current embodiment, an axial direction of the pivotal axis 228 is perpendicular to the longitudinal direction LD of the holding rod 22. When the positioning flange 225 corresponds to and is engaged with one of the positioning recesses 227, the pivotable member 221 are unable to pivot relative to the fixing member 223. In the current embodiment, the at least one of the positioning recesses 227 includes, but not limited to, three positioning recesses 227, and the three positioning recesses 227 are arranged around the pivotal axis 228. Referring to FIG. 4, the fixing member 223 has the positioning flange 225, and the pivotable member 221 includes the three positioning recesses 227. When the positioning flange 225 is engaged with middle one of the three positioning recesses 227, the first tool assembly 24 is in a working state and a longitudinal direction of the rotatable member 242 of the first tool assembly 24 is vertical to the longitudinal direction LD of the holding rod 22. In another embodiment, when the positioning flange 225 is correspondingly engaged with either right or left one of the three positioning recesses 227, the first tool assembly 24 is in a storing state, and a longitudinal direction of the rotatable member 242 of the first tool assembly 24 is parallel to the longitudinal direction LD of the holding rod 22.

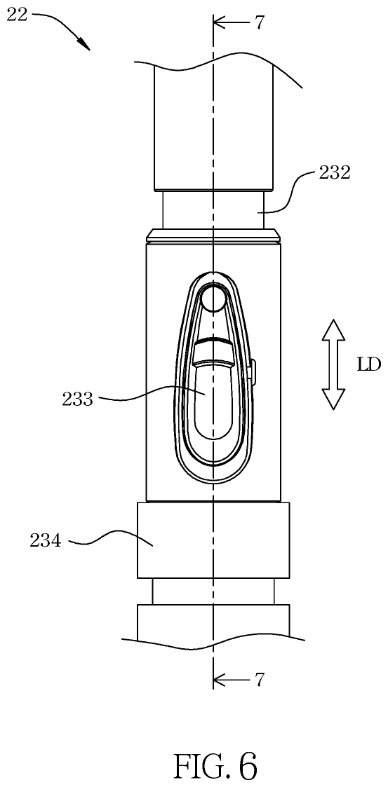

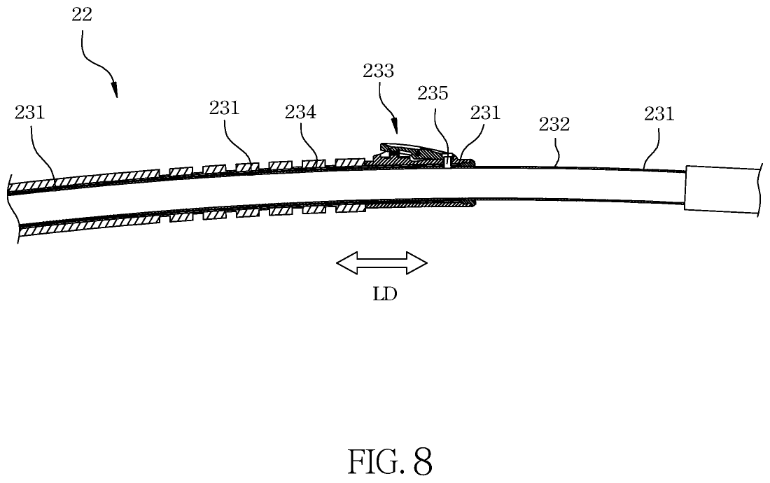

As illustrated in FIG. 6 and FIG. 8, the holding rod 22 includes an inner tube 232, an outer tube 234, and a fixing structure 233, wherein the outer tube 234 fits around the inner tube 232, and the fixing structure 233 is disposed on the outer tube 234. When the fixing structure 233 is in a lock state, the outer tube 234 is unable to move relative to the inner tube 232. When the fixing structure 233 is in an unlock state, the outer tube 234 and the inner tube 232 are manipulatable to move relative to each other in the longitudinal direction LD of the holding rod 2

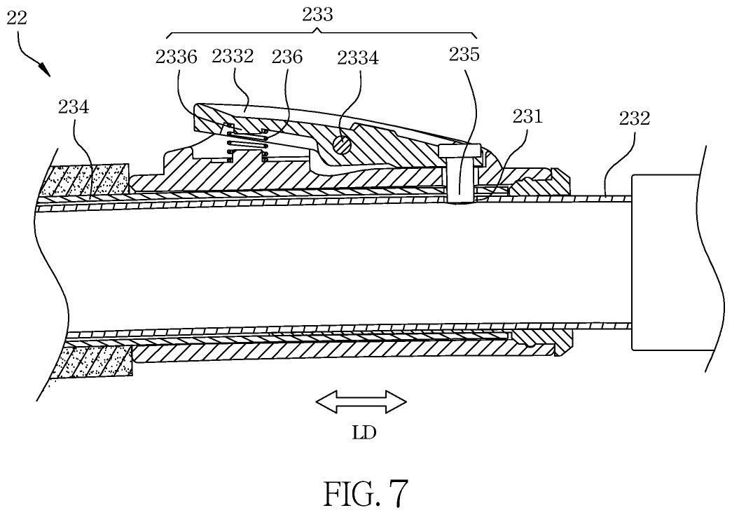

Referring to FIG. 7 and FIG. 8, a wall of the inner tube 232 includes at least one positioning perforation 231, and the fixing structure 233 includes a positioning member 235. When the fixing structure 233 is in the lock state, the positioning member 235 is engaged with the positioning perforation 231, thereby the outer tube 234 and the inner tube 232 are unable to move relative to each other.

The fixing structure 233 includes a third pressed portion 2332, the positioning member 235, and a third resisting portion 2336, wherein the third pressed portion 2332 and the third resisting portion 2336 face opposite directions and are located at a side of a fulcrum 2334 of the fixing structure 233. The positioning member 235 is located at an opposite side of the fulcrum 2334 corresponding to the side of the third pressed portion 2332 and the third resisting portion 2336.

The third resisting portion 2336 is connected to a third elastic member 236. When the positioning member 235 is engaged with the positioning perforation 231, the third resisting portion 2336 is resisted by the third elastic member 236 to make positioning member 235 abut against the positioning perforation 231, thereby the outer tube 234 and the inner tube 232 are unable to move relative to each other. On contrary, when the third pressed portion 2332 is pressed by an external force, the positioning member 235 moves away from the positioning perforation 231 to disengage the positioning member 235 from the positioning perforation 231, so that the fixing structure 233 is in the unlock state, thereby the outer tube 234 and the inner tube 232 are controllably moved relative to each other in the longitudinal direction LD of the holding rod 2. Referring to FIG. 8, in the current embodiment, the inner tube 232 has a plurality of the positioning perforations 231, the user P could engage the positioning member 235 with one of the positioning perforations 231 to adjust the holding rod 22 to an appropriate length that could make the cleaning work more convenient and easier for the user P.

By using the cleaning tool with a curve-shaped holding rod provided by the present invention, the user could easily clean up the dead corner around the obstacles on the high surface of a subject, so that when the user cleans the high surface of the subject with the obstacles, the user don't need to climb high, thereby to decrease the risk of injury caused by falling down from the high place. On the other sides, the dead corners around the obstacles could be easily cleaned up by using the cleaning tool having curve-shaped holding rod, so that it's unnecessary to use other cleaning tools, thereby to save the cost of cleaning work.

It must be pointed out that the embodiment described above is only a preferred embodiment of the present invention. All equivalent structures which employ the concepts disclosed in this specification and the appended claims should fall within the scope of the present invention.

What is claimed is:

1. A cleaning tool, comprising:
a holding rod being curved to form an inner curve and an outer curve;
a first tool assembly rotatably connected to a first end of the holding rod and comprising a first side and a second side which face opposite directions, wherein the first side or the second side is controllably fixed relative to the holding rod to allow either the first side or the second side faces a direction from the outer curve to the inner curve.

2. The cleaning tool of claim 1, wherein the first tool assembly comprises a rotatable member and a connecting portion; the rotatable member comprises the first side and the second side and is rotatably connected to the connecting portion; the connecting portion is fixed to the first end of the holding rod; either the rotatable member or the connecting portion comprises at least one protruding member, and the other one comprises at least one positioning groove; when either the first side or the second side faces the direction from the outer curve to the inner curve, the at least one protruding member is correspondingly engaged with the at least one positioning groove.

3. The cleaning tool of claim 2, wherein the at least one protruding member comprises a first pressed portion, a first abutting portion, and a first resisting portion; the first pressed portion and the first abutting portion are located on a side of the at least one protruding member, and the first resisting portion is located on another side of the at least one protruding member opposite to the side with the first pressed portion and the first abutting portion; the first resisting portion is connected to a first elastic member; when the at least one protruding member is correspondingly engaged with the at least one positioning groove, the at least one protruding member is resisted by the first elastic member to make the first abutting portion abut against the at least one positioning groove; when the first pressed portion is pressed by an external force, the at least one protruding member is moved in a direction toward the first elastic member, so that the first abutting portion is disengaged from the at least one positioning groove, thereby the rotatable member is freely rotatable relative to the connecting portion.

4. The cleaning tool of claim 2, wherein the first tool assembly comprises a rotational axis, and the rotatable member is connected to the connecting portion via the rotational axis; an axial direction of the rotational axis is parallel to a longitudinal direction of the holding rod.

5. The cleaning tool of claim 1, wherein the first end of the holding rod comprises a connecting assembly; the connecting assembly comprises a pivotable member and a fixing member; an end of the pivotable member is connected to the first tool assembly, and another end of the pivotable member is pivotally connected to the fixing member; the fixing member is fixed to an end of a rod body of the holding rod.

6. The cleaning tool of claim 5, wherein either the pivotable member or the fixing member comprises a positioning flange, and the other one comprises at least one positioning recess; when the pivotable member pivots relative to the fixing member, and the positioning flange corresponds to the at least one positioning recess, the positioning flange is engaged with the at least one positioning recess.

7. The cleaning tool of claim 6, wherein the positioning flange comprises a second pressed portion, a second abutting portion, and a second resisting portion; the second pressed portion and the second abutting portion are located on a side of the positioning flange, and the second resisting portion is located on another side opposite to the side with the second pressed portion and the second abutting portion; the second resisting portion is connected to a second elastic member; when the positioning flange is engaged with the at least one positioning recess, the positioning flange is resisted by the second elastic member to make the second abutting portion abut against the at least one positioning recess; when the second pressed portion is pressed by an external force, the positioning flange is moved in a direction toward the second elastic member, so that the second abutting portion is disengaged from the at least one positioning recess, thereby the pivotable member is freely rotatable relative to the fixing member.

8. The cleaning tool of claim 6, wherein the connecting assembly comprises a pivotal axis; the pivotable member is connected to the fixing member via the pivotal axis; the at least one positioning recess comprises a plurality of positioning recesses which are arranged around the pivotal axis; when the positioning flange corresponds to and is engaged with one of the positioning recess, the pivotable member are unable to pivot relative to the fixing member.

9. The cleaning tool of claim 8, wherein an axial direction of the pivotal axis is perpendicular to a longitudinal direction of the holding rod.

10. The cleaning tool of claim 1, wherein the holding rod comprises an inner tube, an outer tube, and a fixing structure; the outer tube fits around the inner tube; the fixing structure is disposed on the outer tube; when the fixing structure is in a lock state, the outer tube is unable to move relative to the inner tube; when the fixing structure is in an unlock state, the outer tube and the inner tube are controllably moved relative to each other in a longitudinal direction of the holding rod.

11. The cleaning tool of claim 10, wherein a wall of the inner tube comprises at least one positioning perforation; the fixing structure comprises a positioning member; when the fixing structure is in the lock state, the positioning member is correspondingly engaged with the at least one positioning perforation, thereby the outer tube and the inner tube are unable to move relative to each other.

12. The cleaning tool of claim 10, wherein the fixing structure comprises a third pressed portion, the positioning member, and a third resisting portion; the third pressed portion and the third resisting portion face opposite directions and are located at a side of a fulcrum of the fixing structure; the positioning member is located at another side of the fulcrum opposite to the side with the third pressed portion and the third resisting portion; the third resisting portion is connected to a third elastic member; when the positioning member is correspondingly engaged with the at least one positioning perforation, the third resisting portion is resisted by the third elastic member to make positioning member abut against the at least one positioning perforation; when the third pressed portion is pressed by an external force, the positioning member moves away from the at least one positioning perforation to disengage the positioning member and the at least one positioning perforation, so that the fixing structure is in the unlock state, thereby the outer tube and the inner tube are controllably moved relative to each other in the longitudinal direction of the holding rod.

13. The cleaning tool of claim 1, further comprising a second tool assembly connected to a second end of the holding rod; wherein the second end is opposite to the first end.
